(19) United States
(12) Patent Application Publication
(10) Pub. No.: US 2006/0248994 A1
(43) Pub. Date: Nov. 9, 2006

(54) UNIVERSAL KNIFE HOLD ASSEMBLY

(75) Inventor: Thomas L. Nadrchal, Mokena, IL (US)

Correspondence Address: HARTMAN & HARTMAN, P.C., 552 EAST 700 NORTH, VALPARAISO, IN, 46383, US

(73) Assignee: SCHEFFER, INC., Merrillville, IN (US)

(21) Appl. No.: 11/424,904

(22) Filed: Jun. 19, 2006

Related U.S. Application Data
(63) Continuation-in-part of application No. 10/908,311, filed on May 6, 2005.
(60) Provisional application No. 60/643,360, filed on Jun. 17, 2005.
(60) Provisional application No. 60/521,494, filed on May 6, 2004.

(51) Int. Cl. B26D 1/00; B23D 25/12

(52) U.S. Cl. 83/13; 83/346

(57) ABSTRACT

A knife holder assembly for a knife cylinder configured to make incisions in a web material, and a method for installing knife blades on the knife cylinder. The knife holder assembly includes a knife holder having a first surface adapted for mating with an outer cylindrical surface of the knife cylinder, a second surface oppositely disposed from the first surface, a sidewall extending between the first and second surfaces, and a bore having an opening in the sidewall. An anchor is received in the bore, and a feature accessible through the second surface of the holder is provided for securing the anchor within the bore. A knife blade is secured to the knife holder with the anchor. Setup time for the knife cylinder can be reduced by moving and/or replacing blades on the knife holder instead of installing, removing, and moving the knife holder on the cylinder.

### CROSS REFERENCE TO RELATED APPLICATIONS

This is a continuation-in-part patent application of co-pending U.S. patent application Ser. No. 10/908,311, filed May 6, 2005, which claims the benefit of U.S. Provisional Application No. 60/521,494, filed May 6, 2004. This application also claims the benefit of U.S. Provisional Application No. 60/643,360, filed Jun. 17, 2005. The contents of these prior applications are incorporated herein by reference.

### BACKGROUND OF THE INVENTION

This invention generally relates to equipment and processes used in the commercial printing industry, including the set-up (“make-ready”) and operation of a variable product rotary cutter that can be used in inline and offline finishing of printed products of commercial offset web presses. More particularly, the invention relates to a knife holder suitable for mounting and use with a variable product rotary cutter.

Rotary cutters are used in the printing industry to sever and perforate, as the case may be, moving web materials such as paper. Incisions are generally made transverse to the direction of web travel, and serve to separate the web into discrete predetermined lengths or create tear lines at predetermined locations along the length of the web. A rotary cutter typically comprises a pair of synchronized counter-rotating knife and anvil cylinders between which the web passes. The knife cylinder is equipped with one or more knife blades (or knives) that generally extend parallel to the rotational axis of the knife cylinder, and cut or perforate the web against the anvil cylinder. In known web-type printing press operations that produce a printed product from a moving paper web, the printed product may pass through other auxiliary equipment performing additional operations before being forwarded to the rotary cutter. A single knife blade can be mounted to the knife cylinder to produce what has been termed a butt cut in web material. Mounting a pair of knife blades circumferentially adjacent each other produces what has been termed a bleed cut, resulting in a trim piece or chip being formed that must be discarded.

Because the circumference of a knife cylinder is fixed, the lengths of the segments into which a web can be cut are varied by changing the circumferential locations of multiple knife blades mounted to the knife cylinder, resulting in multiple cuts being produced in the web with each revolution of the knife cylinder. Rotary cutters designed to be reconfigurable for processing various different products are referred to as variable product rotary cutters, or simply variable rotary cutters. Virtually all variable rotary cutters utilize knife holders (or knife blocks) that house the knife blades. “Make-ready” is a term of art that is understood to mean the process of setting up a rotary cutter by mounting knife holders to a knife cylinder before running a job.

Typical knife holders are either cast or molded to contain a single or double knife, or configured to permit mounting of a single or double disposable knife. In the former case, the holder is replaced along with the used knife blade or blades. In the latter case, only one disposable knife is typically mounted to a single reusable knife holder, and the knife is removed from the holder for replacement. For bleed cuts and other applications requiring two knife blades spaced closely together, a custom knife holder is typically made to house two knife blades with the required blade gap. A completely new knife holder assembly is required to house knife blades with a different blade gap. Because variable rotary cutters are designed to cut products to various desired lengths, the need to invest in custom double knife holders for every possible blade gap can be cost prohibitive. Therefore single knife holders are more popular, but require additional “make ready” time because each and every knife must be accurately mounted onto the knife cylinder.

One configuration of a variable rotary cutter manufactured and sold by the assignee of the present invention employs knife holders mounted to the knife cylinder by a dovetail lock-up design in the surface of the cylinder face. In another configuration, multiple tapped holes are formed in the surface of the cylinder face to clamp knife holders onto the cylinder. Knife holder sizes are matched to the lengths of the knife blade with which they are to be used, and knife blades are mounted in their respective holders off the cutting machine.

During make-ready, the operator must know the format of the finished product including the final product length, the number of product streams that may simultaneously pass through the rotary cutter, and the width of each stream. In addition, it is important to know where these streams will be relative to the centerline (axial midpoint) of the cylinder, i.e., left or right of the centerline. Two product streams side-by-side with widths of less than 12 inches (about 30 cm) are most common, in which case two 12-inch holders, each carrying a 12-inch knife blade, would be used.

Once the above information is retrieved, the knife holders are mounted in the strategic locations both circumferentially and axially on the cylinder surface to produce the desired products. Proper positioning of the knife holders requires a locating device and indexing of the cylinder to ensure proper spacing (blade gap) between knife blades. The knife cylinder is rotated until a location at which a knife blade is required is accessible to the operator. A knife holder (with a mounted knife blade) is placed on the cylinder and its location precisely determined with the locating device. The holder is then secured to the cylinder, after which the cylinder is again indexed to the next location requiring a knife blade. This process is repeated for each knife holder, resulting in a very tedious and time-consuming process.

When the particular job is finished and a new job with a different product format is to be run, all of the knife holders are removed from the cylinder and the entire process is repeated. On occasion, the product lengths might be the same from job to job, however the product stream width and/or location (left or right) often differ, requiring the holders to be removed and remounted left or right to line up with the printed streams. In view of the foregoing, there is a need for a variable rotary cutter and a method for setting up the knife cylinder of such a cutter that is less time consuming and more versatile in terms of the ability to reconfigure the cylinder for different products.

### BRIEF SUMMARY OF THE INVENTION

The present invention provides a knife holder assembly for a knife cylinder configured to make incisions in a web material passing between the knife cylinder and an anvil cylinder adjacent thereto, and a method for installing knife blades on a knife holder. The knife holder assembly is reusable and configured for mounting one or more disposable knife blades to a knife cylinder. With the use of the knife holder assembly and method of this invention, the setup time for the knife cylinder between jobs can be reduced by eliminating the requirement to install, remove, and move knife holders on the knife cylinder after completing one job and preparing for another with a different product format. As such, a single make-ready operation can be performed in preparation for multiple jobs with different product formats.

The knife holder assembly comprises a knife holder having a first surface adapted for mating with an outer cylindrical surface of the knife cylinder, a second surface oppositely disposed from the first surface, a sidewall extending between the first and second surfaces, and a bore having an opening in the sidewall. An anchor is received in the bore, and means accessible through the second surface of the holder is provided for securing the anchor within the bore. At least one knife blade is secured to the knife holder with the anchor.

The method of this invention entails mounting at least one knife holder to an outer cylindrical surface of a knife cylinder, by which at least one knife blade can be mounted to the knife cylinder. The knife holder has a first surface mating with the outer cylindrical surface of the knife cylinder, a second surface oppositely disposed from the first surface, a sidewall extending between the first and second surfaces, and a bore having an opening in the sidewall. The knife blade is placed alongside the sidewall of the knife holder, after which an anchor is secured within the bore of the holder with securing means accessed through the second surface of the knife holder. Securing the anchor with the securing means causes the knife blade to be secured to the knife holder.

In view of the above, the present invention provides the ability to equip a knife cylinder with one or more knife holder assemblies that can be circumferentially positioned about the circumference of the knife cylinder. Knife blades can be mounted with any of the knife holder assemblies, which can extend the axial length of the knife cylinder and be configured to permit multiple knife blades of different lengths to be mounted end-to-end across the entire axial length of the knife cylinder, and subsequently removed without any requirement to remove or reposition the knife holder assemblies. As such, the present invention enables a variable rotary cutter to be prepared for performing a series of print jobs having different product formats with only a single make-ready operation. In particular, instead of the prior art practice of performing a make-ready for each individual job by moving knife holders on a knife cylinder and/or removing knife holders from a knife cylinder to permit installing knife holders of different lengths, etc., the present invention permits a rotary cutter to be reconfigured for multiple different product formats by moving, removing, and/or installing individual knife blades without disturbing the knife holders that were previously and precisely located on the knife cylinder. Instead, reconfiguration can entail repositioning or removing any of the knife blades on any of the knife holder assemblies through the operation of the anchor and securing means, which can be performed from the outer surface of the knife holder and therefore without the need to remove any of the knife holders or any other components mounted to the knife cylinder.

Other objects and advantages of this invention will be better appreciated from the following detailed description.

### BRIEF DESCRIPTION OF THE DRAWINGS

FIG. 1 is a cross-sectional view of a knife cylinder of a variable rotary cutter in accordance with the present invention.

FIG. 2 represents different combinations of knife positions and sizes that can be accommodated on a knife holder of a type suitable for use with the knife cylinder of FIG. 1.

FIG. 3 is an exploded view of a knife holder assembly with which a single knife blade is secured in accordance with a first embodiment of the invention.

FIG. 4 represents a cross-sectional view of the knife holder assembly of FIG. 3 assembled and installed on a knife cylinder.

FIG. 5 depicts a knife holder assembly with which two knife blades are secured in accordance with a second embodiment of the invention.

FIG. 6 represents a cross-sectional view of the knife holder assembly of FIG. 5 assembled and installed on a knife cylinder.

### DETAILED DESCRIPTION OF THE INVENTION

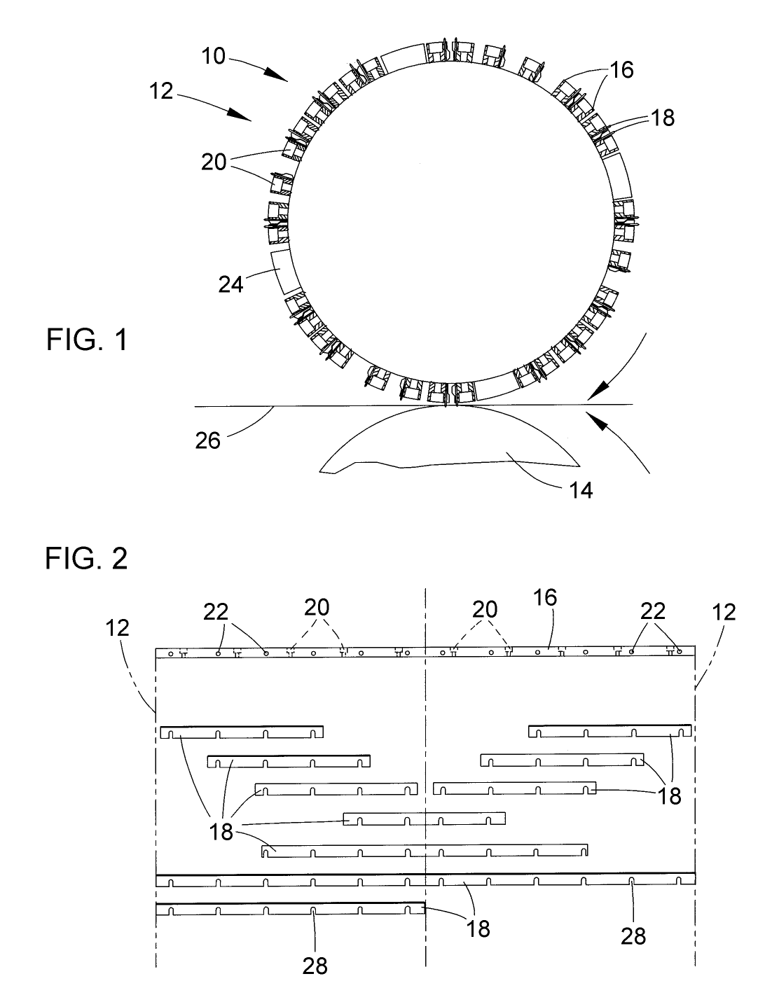

FIG. 1 represents a knife cylinder 12 and a portion of an adjacent anvil cylinder 14, which together make up a variable rotary cutter 10 adapted to perform an operation on a web material 26 as understood by those skilled in the art. The knife cylinder 12 can have any suitable construction and a diameter and length appropriate for the particular application. As an example, an industry-standard size for knife cylinders is an axial length of about forty inches (about 100 cm), with a suitable circumference being about 44.50 inches (about 116 cm). The knife cylinder 12 is shown as being equipped with a series of knife holders 16 spaced circumferentially around substantially its entire circumference. The holders 16 are shown as having concave and convex radially inner and outer surfaces, respectively, and as having holes 20 sized to receive bolts (not shown) for securing the holders 16 to the cylinder 12 in accordance with conventional practices, though other holder mounting techniques are also within the scope of this invention. The knife holders 16 are also formed to have bores 22 (FIG. 2) oriented transverse to the holes 20 for mounting knife blades 18 to the cylinder 12, such as with threaded fasteners, though other blade mounting techniques are within the scope of this invention. In their role as mounting and supporting the blades 18, the knife holders 16 are preferably formed of a rigid material, such as machined from a bar of aluminum or another sufficiently strong and rigid material. As understood in the art, blades 18 mounted to immediately adjacent pairs of holders 16 are adapted to produce a bleed cut, while blades 18 that are spaced apart from other blades 18 will generally be used to produce butt cuts. Those skilled in the art will also appreciate that the blades 18 can be configured to completely sever or only perforate the web material 26, depending on the particular job being performed.

Each of the knife holders 16 in FIG. 1 is represented as having a knife blade 18 mounted thereto, though it is a preferred aspect of the invention that less than all, and more often less than half the holders 16 would have blades 18 mounted thereto. FIG. 2 depicts one of the knife holders 16, which is represented as being sized to extend the entire width (axial length) of the knife cylinder 12 (the extremities of which are represented by phantom lines). As such, the knife holder 16 is able to mount a single knife blade 18 that extends the entire length of the knife cylinder 12, or multiple knife blades 18 that can be mounted end-to-end or spaced apart along the entire length of the cylinder 12 or any portion or portions thereof. As an alternative to the single holder 16, multiple shorter holding devices could be placed end-to-end to yield a composite knife holder 16 that covers the entire length of the cylinder 12. In either case, the result is termed herein a “universal” knife holder having the capability of simultaneously mounting one or more knife blades 18 of different lengths along the entire length of the knife cylinder 12 or any portion or portions thereof, as evident from FIG. 2. For example, based on the above-noted standard cylinder length of forty inches, two 12-inch (about 30 cm) knife blades 18 can be mounted at the lefthand and righthand extremities of the universal knife holder 16, as represented by the top row of blades 18 in FIG. 2. The second and third rows show two 12-inch blades positioned axially inwardly from the positions shown in the first row, while the fourth row shows a single 12-inch blade centrally located on the holder 16. As evident from FIG. 2, any one of the 12-inch knife blades 18 could be replaced with a 24-inch (about 60 cm) knife blade 18 depicted in the fifth row of FIG. 2, or a 20-inch (about 50 cm) knife blade 18 depicted in the seventh (lowermost) row of FIG. 2. As also evident from FIG. 2, the holder 16 can accommodate a single 20-inch knife blade 18 (seventh row), single 24-inch knife blade 18 (fifth row), single 40-inch (about 100 cm) knife blade 18 (sixth row), or any other length up to the full axial length of the particular cylinder 12.

By equipping the knife cylinder 12 of FIG. 1 with multiple universal knife holders 16, each adapted to mount multiple knife blades 18 of different lengths over the full length of the cylinder 12, knife blades 18 can be readily positioned on the cylinder 12 relative to one or more printed product streams without the need of moving a knife holder 16, as is conventionally required by the prior art practice of specifically sizing each knife holder to the length of the knife blade with which it is to be used. In addition, while the prior art practice requires mounting knife blades to their respective holders off the rotary cutter 10, knife holders 16 of this invention can remain mounted to the knife cylinder 12 with only the blades 18 being removed, repositioned, or installed in the pre-mounted knife holders 16 in accordance with the particular requirements of the product being cut.

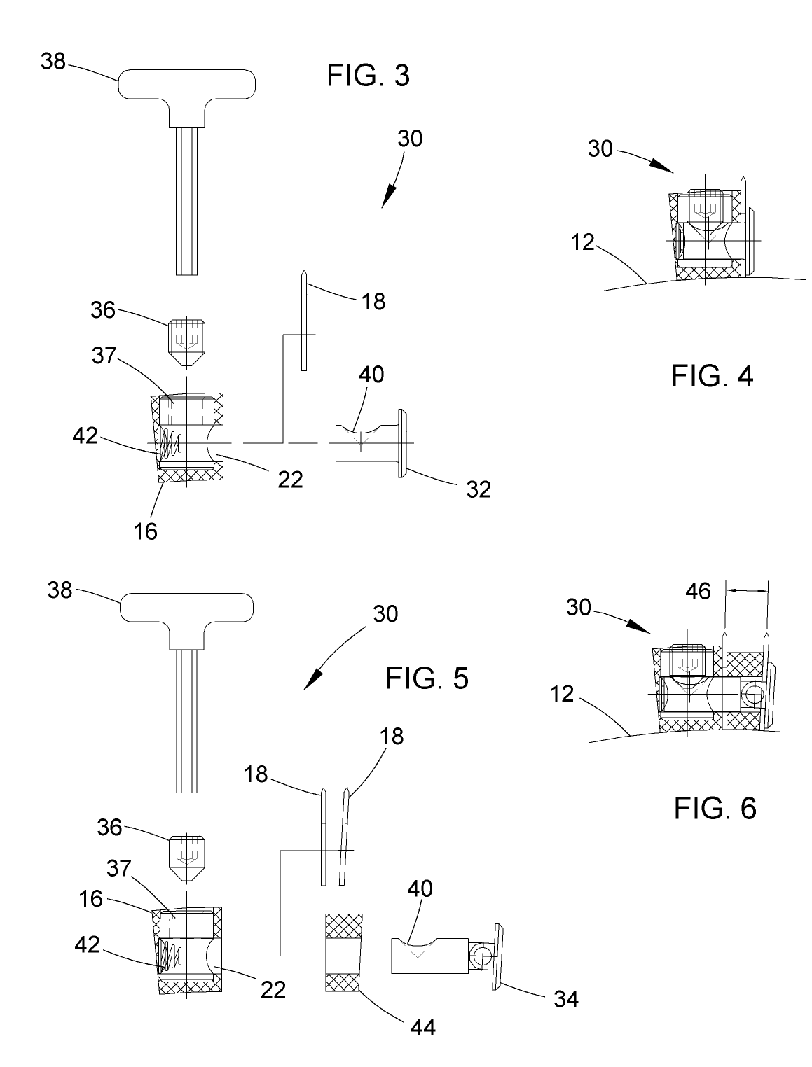

To greatly facilitate the moving, removal, and installation of knife blades 18, the holders 16 are preferably configured in accordance with the embodiments of FIGS. 3 through 6, which use consistent reference numbers to identify functionally similar structures. The holders 16 (shown in cross-section in FIGS. 3 through 6) are components of what will be termed herein a universal knife holder assembly 30, which is configured to have the ability to mount a single blade 18 (FIGS. 3 and 4) or multiple blades 18 (FIGS. 5 and 6). As discussed in reference to FIGS. 1 and 2, the holder 16 shown in FIGS. 3 through 6 has a radially inward concave surface for mating with the knife cylinder 12, and an oppositely-disposed radially outward convex surface. As also discussed above, the holder 16 can be secured to the knife cylinder 12 with bolts (not shown) that pass through radially oriented holes (20 in FIGS. 1 and 2) in accordance with conventional practice, though other holder mounting techniques are also within the scope of this invention.

In addition to the holder 16, the holder assembly 30 shown in FIGS. 3 and 4 comprises at least one anchor pin 32. When the holder 16 is mounted to the outer cylindrical surface of the knife cylinder 12 (FIG. 4) so as to be parallel to the axis of the knife cylinder 12, the pin 32 is oriented generally in the circumferential direction of the knife cylinder 12 as a result of being inserted through a slot or hole 28 in the knife blade 18 and into one of the bores 22 formed in a sidewall of the holder 16. A set screw 36 is threaded into a threaded hole 37 formed in the outer convex surface of the holder 16, and is therefore accessible by a tool 38 from the top of the holder 16 (in the radial outward direction of the cylinder 12). When threaded into the hole 37, the set screw 36 secures the anchor pin 32 to the holder 16. As shown in FIG. 4, the set screw 36 preferably engages a dimple 40 on the shank of the anchor pin 32, with the nose of the screw 36 cooperating with the wall of the dimple 40 to force the pin 32 deeper into the holder 16 so that the head of the anchor pin 32 clamps the knife blade 18 against the sidewall of the holder 16. The anchor pin 32 is preferably biased with a spring 42 that causes the pin 32 to extend from the holder 16 when the set screw 36 is loosened to permit knife installation and removal. While the set screw 36 and pin 32 are believed to be preferred as a matter of convenience and practicality, it should be understood that various other methods and components are capable of being accessed through the outer convex surface of the holder 16 to secure the pin 32 within its bore 22, including various types of fasteners that can be simultaneously secured in the holder 16 and engaged with the pin 32 to generate the required clamping force.

As illustrated in FIGS. 5 and 6, if a double knife blade application is desired, the universal knife holder assembly 30 can be converted from a single-blade unit (FIGS. 3 and 4) to a double-blade unit with the addition of a spacer 44. The conversion process entails loosening the set screw 36 to allow removal of the anchor pin 32, placing the spacer 44 against the installed knife blade 18, and then placing a second knife blade 18 against the spacer 44 so that the second knife blade 18 is spaced from the first by a desired blade gap 46 established by the width of the spacer 44. In place of the original anchor pin 32, a pin 34 with its head attached by a hinge to its shank is preferably inserted through the blades 18 and spacer 44 and into the bore 22 of the holder 16, and then secured with the set screw 36. The head of the pin 34 is able to pivot and conform to the angle of the second knife blade 18, whose angle relative to the holder 16 varies with the blade gap 46 as a result of the curvature of the knife cylinder 12. As such, the hinged pin 34 eliminates the need for a custom knife holder and custom anchor pin for use when the knife holder assembly 30 is being changed over from a single to a double knife application, or when a different blade gap 46 is required. Spacers 44 with various widths and hinged pins 34 can be produced to provide the end user with a variety of double knife blade gap settings. Additional knife blades 18 can be mounted with a series of spacers 44 and hinged pins 34 of sufficient lengths to create a multiple knife blade assembly as well.

In view of the above, the universal knife holder assembly 30 in accordance with the invention is able to greatly simplify knife replacement while the holder 16 remains mounted on the knife cylinder 12, as well as enables a single-knife blade application to be converted to a multiple knife blade application having selective gap distances with minimal effort and associated cost. The flexibility to mount multiple knife blades 18 with a single holder 16 drastically reduces the make-ready time for knife blade placement since fewer individual knife blades 18 need to be positioned on the knife cylinder 12. The top lock-up design feature of the assembly 30 is also advantageous, in that it eliminates the need for any grooves or tool access in adjacent cylinder holders 16 or spacers 24. As a result, preferred knife holder assemblies 30 of this invention can be mounted immediately adjacent each other on the knife cylinder 12, as shown in FIG. 1.

Referring again to FIG. 1, the placements of the knife holders 16 are intended to depict a make-ready that can be used to process a large variety of product lengths and formats by appropriately removing, repositioning and installing blades 18 on the holders 16. As an operator reconfigures the cylinder 12 from job to job, knife blades 18 can be repositioned along the lengths of their current holders 16, removed entirely from the cylinder 12, or removed from their current holders 16 and mounted in a different holder 16 as required. The unused knife holders 16 remain on the cylinder 12, and for this reason their radially outer surfaces are configured to allow the unused holders 16 to serve as spacers between knife holders 16 on which knife blades 18 are mounted. In other words, the unused knife holders 16 fill voids between adjacent knife holders 16 and may contact but otherwise do not perform an operation on the web material 26. FIG. 1 shows additional spacers 24 as also being mounted to the cylinder 12 at locations where a knife blade 18 will not be required, at least for the immediate future.

The ability to position knife blades 18 of different lengths across the full length of a knife cylinder 12 without removing the holders 16 and the ability to mount knife blades 18 to different holders of predetermined locations dramatically reduces the time required to prepare a rotary cutter for many typical product formats encountered in the commercial printing industry. As such, a single make-ready operation can be performed on a variable rotary cutter for a series of print jobs having different product formats. Otherwise, if circumstances necessitate, bolts securing a knife holder 18 to the cylinder 12 can be loosened and the knife holder 16 repositioned slightly to alter product lengths from those available with the existing positions of the knife holders 16 on the knife cylinder 12.

While the invention has been described in terms of a preferred embodiment, it is apparent that other forms could be adopted by one skilled in the art. For example, the knife cylinder 12, knife holder assembly 30, knife holders 16, blades 18, pins 32 and 34, etc., could differ in appearance and construction from the embodiments shown in the Figures. Therefore, the scope of the invention is to be limited only by the following claims.

1. A knife holder assembly for a knife cylinder configured to make incisions in a web material passing between the knife cylinder and an anvil cylinder adjacent thereto, the knife holder assembly comprising:
a knife holder having a first surface adapted for mating with an outer cylindrical surface of the knife cylinder, a second surface oppositely disposed from the first surface, a sidewall extending between the first and second surfaces, and a bore having an opening in the sidewall;
an anchor received in the bore;
means accessible through the second surface for securing the anchor within the bore; and
at least one knife blade secured to the knife holder with the anchor.

2. The knife holder assembly according to claim 1, wherein the anchor comprises a head, the head abutting the at least one knife blade so as to clamp the at least one knife blade against the sidewall of the knife holder.

3. The knife holder assembly according to claim 2, wherein the anchor comprises a shank and a hinge that pivotally secures the head to the shank.

4. The knife holder assembly according to claim 1, wherein the securing means comprises a threaded hole in the second surface, a threaded member threaded into the threaded hole, and means, for causing the anchor to be forced into the bore as the threaded member is threaded into the threaded hole.

5. The knife holder assembly according to claim 1, wherein the anchor clamps the at least one knife blade against the sidewall of the knife holder.

6. The knife holder assembly according to claim 1, wherein the at least one knife blade comprises first and second knife blades.

7. The knife holder assembly according to claim 6, wherein the anchor clamps the first knife blade against the sidewall of the knife holder.

8. The knife holder assembly according to claim 7, further comprising a spacer between the first and second knife blades, the anchor clamping the second knife blade against the spacer.

9. The knife holder assembly according to claim 8, wherein the anchor comprises a head, the head abutting the second knife blade so as to clamp the second knife blade against the spacer and clamp the first knife blade against the sidewall of the knife holder.

10. The knife holder assembly according to claim 9, wherein the anchor comprises a shank and a hinge that pivotally secures the head to the shank.

11. The knife holder assembly according to claim 1, wherein the knife holder assembly is mounted to the outer cylindrical surface of the knife cylinder so as be substantially parallel to an axis of the knife cylinder.

12. A knife cylinder comprising a plurality of knife holder assemblies in accordance with claim 1, the knife holder assemblies being mounted to the outer cylindrical surface of the knife cylinder so as to be circumferentially positioned about the circumference of the knife cylinder, each of the knife holder assemblies extending the entire axial length of the knife cylinder and being configured to permit multiple knife blades of different lengths to be mounted therein end-to-end across the axial length of the knife cylinder in its entirety, at least one of the knife holder assemblies not having a knife blade mounted therewith.

13. The knife cylinder according to claim 12, wherein most of the knife holder assemblies do not have a knife blade mounted therewith.

14. The knife cylinder according to claim 12, wherein the knife holder assemblies substantially fill the entire circumference of the knife cylinder.

15. A method of mounting at least one knife blade to a knife cylinder configured to make incisions in a web material passing between the knife cylinder and an anvil cylinder adjacent thereto, the method comprising:
mounting a knife holder to an outer cylindrical surface of the knife cylinder, the knife holder having a first surface mating with the outer cylindrical surface of the knife cylinder, a second surface oppositely disposed from the first surface, a sidewall extending between the first and second surfaces, and a bore having an opening in the sidewall;
placing the at least one knife blade alongside the sidewall of the knife holder; and then
securing an anchor within the bore with securing means accessed through the second surface of the knife holder, wherein securing the anchor with the securing means causes the at least one knife blade to be secured to the knife holder.

16. The method according to claim 15, wherein the placing step further comprises placing at least a second knife blade alongside the sidewall of the knife holder, and the securing step causes the at least one knife blade and the at least second knife blade to be secured to the knife holder.

17. The method according to claim 15, further comprising:
mounting a plurality of additional knife holders on the outer cylindrical surface of the knife cylinder so as to be circumferentially positioned about the circumference of the knife cylinder, each of the additional knife holders having a first surface mating with the outer cylindrical surface of the knife cylinder, a second surface oppositely disposed from the first surface, a sidewall extending between the first and second surfaces, and a bore having an opening in the sidewall, at least some of the additional knife holders extending the axial length of the knife cylinder; and then
securing at least a first knife blade in at least a first of the additional knife holders while not mounting any knife blades in at least a second of the additional knife holders.

18. The method according to claim 17, wherein the step of securing the first knife blade in the first additional knife holder comprises placing the first knife blade and at least a second knife blade alongside the sidewall of the first additional knife holder, and then securing the first and second knife blades with an anchor within the bore of the first additional knife holder using securing means accessed through the second surface of the first additional knife holder.

19. The method according to claim 18, wherein the first and second knife blades are mounted in the first additional knife holder so as to be spaced apart by a spacer, the method further comprising rotating the knife cylinder to form incisions with the first and second knife blades in the web material passing between the knife and anvil cylinders, the incisions being spaced apart in the web material as a result of the spacing between the first and second knife blades.

20. The method according to claim 17, further comprising:
rotating the knife cylinder to form incisions spaced apart in the web material passing between the knife and anvil cylinders;
reconfiguring the knife cylinder without repositioning the knife holder or any of the additional knife holders on the knife cylinder by performing at least one step chosen from the group consisting of repositioning the at least one knife blade on the knife holder, removing the at least one knife blade from the knife holder, and mounting at least one additional knife blade in at least one of the additional knife holders; and then
rotating the knife cylinder to form incisions in a second web material passing between the knife and anvil cylinders.
